(19) United States
(12) Patent Application Publication
(10) Pub. No.: US 2009/0138920 A1
(43) Pub. Date: May 28, 2009

(54) Video display device and method for communication of multiple audio and video selection of an aircraft

(76) Inventor: Atul Mansukhlal Anandpura, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/284,293

(22) Filed: Sep. 19, 2008

Related U.S. Application Data
(60) Provisional application No. 60/973,887, filed on Sep. 20, 2007.

(51) Int. Cl. H04N 7/18

(52) U.S. Cl. 725/76

(57) ABSTRACT

A multimedia playing device for use in a passenger cabin having a plurality of seats for multiple passengers. The device employs an electronic component to ascertain the individual seat location of each device from the plurality of seats. User rights based on the individual seat location provide the user with varying levels of access to stored audio and video on the device.

User communications are also communicable to the crew of the plane or train using wireless transmissions to and from the individual playing devices. Electronic storage of data for production of audio and video is minimized by the pre-loading of portions of available movies and songs and the like, and subsequent streaming wirelessly of remaining portions based on the user's choice.

This application claims priority to U.S. Provisional Application No. 60/973,887 filed Sep. 20, 2007 and incorporated in its entirety by reference herein.

### BACKGROUND OF THE INVENTION

(1) Field of the Invention

The disclosed device relates generally to portable video displays and audio visual players of multimedia and the like. More particularly, it relates to a portable video display device adapted to receive and display video and audio in real time, on an aircraft or in other portable venues, and to allow communication to and from passengers with a self-locating video device.

(2) Prior Art

Passengers on aircraft are frequently presented with the prospect of spending many hours sitting in cramped conditions. One mode of keeping the passengers entertained and from continually concentrating on their abysmal situation, is to provide movies for their viewing.

Unfortunately, many passengers have a poor view of the few viewing screens in the aircraft. Further, the single movie offered by the airline may have been seen already by many passengers, or might be too mature for youthful passengers. Still further, such viewing requires that the cabin be dimmed and does not allow for any passenger selection or input or feedback.

Accordingly, there is an unmet need for a device and method which will provide airline passengers and passengers in similar situations such as those on a bus, with better forms of passenger entertainment. Such a device should provide the passenger with a plurality of different viewing options to choose from. Such a video display should be small enough for distribution to each passenger on a cramped aircraft. Such a device should provide a method of media input to the device itself, to allow fast programming due to trip duration, but also needs to provide for inexpensive construction. Further, such a device should provide substantially instant viewing of available video selections, and onboard ascertaining by the device of time left in the flight, so that passengers on shorter flights will be able to choose and watch the movie or video of their choice and finish before the end of the flight. Finally, such a device, optionally, should provide for two-way communication so the device can surf the internet if desired, and, should optimally ascertain its seat position in the airplane or bus so that the passenger can send information to the crew and the crew will know which passenger sent the information.

### SUMMARY OF THE INVENTION

There is disclosed and described herein a portable video and audio multimedia device which employs an onboard screen display viewable by the user. Also provided are a keypad or a touch screen having displayed keys, either of which would provide an intuitive set of input keys for user input. In an optional but particularly preferred and useful mode of the device, the device has an onboard receiver which will ascertain in which seat the device is located in a plane or other portable venue having seats for passengers, through the provision of a means for seat location and identification. In the current preferred mode this location is ascertained by the interaction of the device and an RFID engaged within the passenger seat. The RFID device is programmed to identify the seat to which it is engaged and the device herein is adapted with software and receiving means to energize the RFID to transmit the location information to the device to thereby passively or actively communicate to the device the seat location to which it has been placed. Employing such a self-identifying means for location determination will also allow such devices to be pre-ordered and pre-programmed in a service for users in advance. Once so programmed, they are also programmed to become activated once the device is placed in a seat and identifies its respective cabin location.

The video display is engaged with software and hardware onboard the device rendering it capable of displaying any of a plurality of different movies and/or videos which may be transmitted to the device concurrently while the users are in the passenger cabin. Or, it may be preprogramed in advance beforehand, as the case may be in a another mode of the device. Such data transmission of digital information to be played as audio or video on the video displays, may be by Blue tooth, WiFi, RF, infrared, or other means of communication to the device from a node engaged to electronic storage of various audio and visual and multimedia programs or even video games. Currently, a plurality of different audio and video selections, payable on each display device, are broadcast in a single datastream and decoded by the individual display devices in real time. All the users in the passenger cabin as such, can choose from any of the plurality of audio or video choices being concurrently broadcast in the data stream. Of course multiple frequencies of multiple data streams may be employed, but currently a single digital stream is preferred, especially in an aircraft situation where broadcasts are prohibited.

The different available videos, audio, multimedia, internet channel, games and other storable or streaming electronic entertainment and information available to the individual user of the device are concurrently communicated to each respective individual device located on the aircraft. This communication would be accomplished employing a wireless network within the cabin such as WiFi or should radio interference in the cabin be an issue, through infrared or other light spectrums invisible to the eye but capable of one or preferably two-way communication.

In use in a portable passenger oriented venue such as an aircraft, the logistical challenges of loading multimedia content into the device is greatly reduced using this wireless multi-stream mode in a single digital channel of communication. It also allows the user to choose from a wide variety of available content being concurrently broadcast in the cabin, which is only limited by the storage and communication capacity of the server located on the aircraft.

In a particularly preferred mode of the device, each display unit has sufficient electronic memory onboard to cache or store a portion of the streaming available movies and videos or other multimedia made available to the passengers. In this fashion, the individual devices may be loaded onto the aircraft with little or no multimedia stored upon them. They can then download and store a portion of each of the available movie or video offerings in the data stream in advance, while the plane is loading or being cleaned. By pre-storing the media offerings being made available for the user in this fashion, passengers on short flights will still be able to watch their desired movie or video without waiting for it to load into the device after the flight has started. Combined with the automatic seat identification component, passengers who know their seat assignment can order the devices in advance programmed with the media they wish to view. The display devices will be activated to display the pre-ordered media once they are placed in the a seat and the onboard means for seat identification identifies that seat and what that passenger has ordered.

Or, in another mode, the devices can be preprogrammed with portions of available shows and media from the decoded data stream, and once placed in a seat, the device software can initiate it to transmit the seat location to a server which will then authorize the devices to display media which has been ordered or payed for in advance by a passenger in that seat.

In all modes of the device, memory requirements for the device itself are reduced since the entire file for each video need not be loaded into the display unit memory. As noted, from the single or multiple streams of data, only a portion of the audio and video offerings is decoded and stored and the remainder provided during the trip once the user chooses. Further, the need to preload the devices prior to placing them onto the aircraft is also eliminated since they may be programmed onboard with data in real time by decoding it from a data stream thereby eliminating the large amount of memory that might be required to store multiple movies and videos on each display device permanently.

Because of the restrictive requirements on an aircraft for transmission of data due to potential interference with the aircraft systems, a preferred mode of the device and method will have one way transmission of media which requires narrow bandwidth, and very short identification transmissions or selection transmissions from the devices themselves. These device transmissions can be eliminated or minimized using the means for seat location identification in the display component itself as the various display components loaded onto a flight may be pre programmed with all the seats and which seat has authorized or ordered which individual portion of the offered media from the datastream. Once located, the display component would ascertain its location, lookup what is authorized for that seat, and then allow the user in that seat to access media from that being broadcast and decoded from the data stream on the display component that is authorized.

Also in a preferred mode, the devices would be provided electronically with data as to the flights for the airline and a means to determine which flight the device is actually loaded upon. In this fashion, in an especially preferred mode of the device, onboard software adapted to the task, will ascertain how much time is still available before the flight will land, so as to notify the user if there is sufficient time to watch the video or listen to the audio they have chosen or intend to choose from the different offerings in the broadcast datastream.

As noted, in addition to each device determining which flight it is on, each device can determine in which seat the device has been located. This means for individual seat location identification is provided by employing RFID's or similar passive or active devices, which will communicate a signal to the device when the display device is placed on the seat in close proximity to the RFID. Consequently, the individual devices can be placed on each seat in the aircraft, thereby placing them in proximity to the RFID in each individual seat. The RFID's are programmed with a location identifier which is then communicated to the display device located in the seat or passenger's lap. Using this individual seat identifier, and a wireless link to a server or other means to wirelessly communicate aboard the aircraft which identifies the flight the device is riding upon, each device will be able to identify where it is on the flight, and on which flight it is located. Very little communication from the display device is required for such identification and location information.

The device will use this individual seat location and specific aircraft flight information, and a clock or timer or software adapted to the task, to continually ascertain if time is sufficient for a user, to watch the video, movie, or other multimedia which the user may choose from the menu offered and being broadcast simultaneously to the display devices in the passenger cabin.

Further, the individual respective seat location stored on each individual device, may be employed to further enhance the user's time on the flight, and to enhance crew effectiveness in providing services to each user having a device. This individualized seat location information may be employed by the user to communicate information to the crew of the aircraft. For example a passenger may order a drink from their seat, and the device, knowing its location from the RFID information, will transmit the order to the crew who can bring the drink. Using the onboard computer and server to communicate with each device, the available food for in-flight service or other items providable or saleable to each individual passenger may be broadcast to each individual device.

Employing software adapted to the task, users can then choose from the available items and order them electronically. The orders would be transmitted over the onboard two-way wireless communications system using WiFi, Blue tooth, Infrared, or other wireless means of communication with the aircraft computer and server and each individual device.

In this fashion, individualized orders for food, drink, merchandise, or anything made available on the menu on each device, may be communicated to the flight crew for provision to each passenger. Each order, from each passenger, is provided and related to the identified seat in which the device has ascertained its respective location making the provision of service to each passenger much easier for the flight crew who will know the passenger's order and exact location.

In an extension of this mode of employment of the device, each device might also be wirelessly communicated in the datastream with catalogs of goods or services available for order by each passenger much like current in-flight catalogs. Passengers employing individual such display devices will be able to input information to order from the broadcast and electronically stored catalogs and each individualized order may be stored by the computer on the aircraft for delivery after the flight. Since each device knows its seat location automatically, should delivery of goods be handled at the end of the flight, the orders may be bagged and organized by seat number and thereafter tendered to the passengers in an orderly fashion as they exit the aircraft in lines which generally form by seat location.

In the timing mode, if the passenger chooses a movie or video to view, using the onboard means for determining remaining flight time, the display device will ascertain how much of the movie is located in the cache or onboard memory already, and the duration of time left in the flight based on the flight information which is communicated wirelessly to each device as they are located in the seats prior to loading of passengers. Should insufficient time be determined to watch the movie or video ordered from the menu on an individual device, the passenger will be notified so that they are not disappointed in having to exit the flight before the end of the chosen entertainment.

This mode of the device would be especially important if turning off the devices is handled by the onboard computer on the aircraft because of non-interference requirements during take off and landing. It is envisioned that all of the devices on an aircraft may have to be turned off for durations of time during take off and landing and that a signal from the aircraft computer over a wireless communication would provide means to turn on, and off, all the devices on a flight at once. Ascertaining remaining use time would therefor be especially important to prevent passenger dissatisfaction.

Also preferred as one channel broadcast to each of the onboard devices will be a video graphic display of the aircraft (or bus or other vehicle) location on the map of the world using GPS. This will allow passengers to track their progress. The GPS may also be used by the device, along with flight information and software adapted to the task, to ascertain if sufficient time is left for the chosen video or program by the passenger.

In use, in a preferred mode, each respective hand-held device will employ a microprocessor, software, and memory, to decode the plurality of simultaneous movie or multimedia offerings in a single broadcast digital data stream or from multiple streams. Each device would best be provided with a multi-hour onboard power supply. The LCD display will be sufficiently bright to be viewed in an undimmed cabin. It also provides music channels, flight path information and games.

The devices may also be equipped for passenger input for such things as the passengers frequent flyer information. In this fashion passengers will be allowed to order products, travel services, and other items using the stored payment information relating to their identified frequent flyer number or other identification means. In instances where very-preferred passengers are onboard, since the device self locates, a message can be sent to the crew noting the identity of the valued customers in individual seats so the crew can pay special attention to their needs.

In operation, the devices may be rented or given to users or passengers by placing one in each seat on the plane or other multi-seat vehicle such as a bus for the long ride ahead. Wireless communication would employ an antenna and onboard receiver or an infrared receiver and transmitter in the plane, train or bus or other means for one or two way wireless communication. Software onboard for the noted functions would run on a computing device or microprocessor adapted to the task and having appropriate audio and video inputs and outputs.

It is to be understood that the invention is not limited in its application to the details of construction, and to the arrangement of the components or method steps set forth in the following description or illustrated in the drawings. The invention is thus capable of other embodiments and of being practiced and carried out in various ways and in different order of execution. Also, it is to be understood that the phraseology and terminology employed herein are for the purpose of description and should not be regarded as limiting.

As such, those skilled in the art will appreciate that the conception upon which the system and method is based may readily be utilized as a basis for designing of other methods and software driven systems for carrying out the several purposes of the present invention. It is important, therefore, that the claims be regarded as including such equivalent construction insofar as they do not depart from the spirit and scope of the present invention.

It is an object of this invention to provide a video display device providing video to users in airplanes, buses, and trains for long trips thereon.

It is a further object of this invention to provide such a device that also provides a user keypad which is intuitive and easy to use to allow the user to choose the viewing channel desired for displayed video.

It is a further object of this invention to provide for a memory cache for each multimedia or video or audio offering in the data stream, so that the available videos can begin to load before the passengers arrives, and all the devices may decode portions of the datastream for their chosen audio or video thereafter.

Yet another object of this invention is the employment of means for the video device to ascertain the exact seat in which it is located so that orders or requests may be transmitted to the crew by the passenger for personalized response.

Yet another object of this invention is the minimizing of two way communications required because of the environment on an aircraft may restrict such two-way communication.

These together with other objects and advantages which will become subsequently apparent reside in the details of the construction and method as more fully hereinafter described and claimed, reference being had to the accompanying drawings forming a part thereof, wherein like numerals refer to like parts throughout.

### BRIEF DESCRIPTION OF DRAWING

FIG. 1 depicts a perspective view of the display device showing the display screen which may employ a touch screen or keypad for user input to choose which of the offerings communicated in the data stream they wish to watch or hear.

FIG. 2 depicts a section of a typical passenger cabin showing seats and seat identifiers as RFID chips.

### DETAILED DESCRIPTION OF PREFERRED EMBODIMENTS

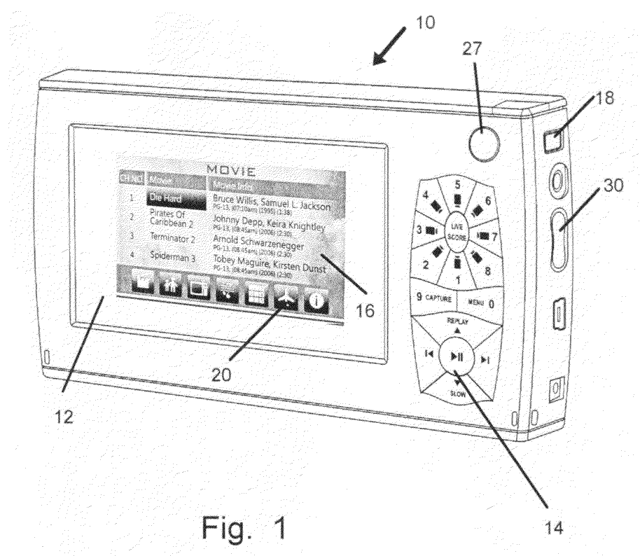

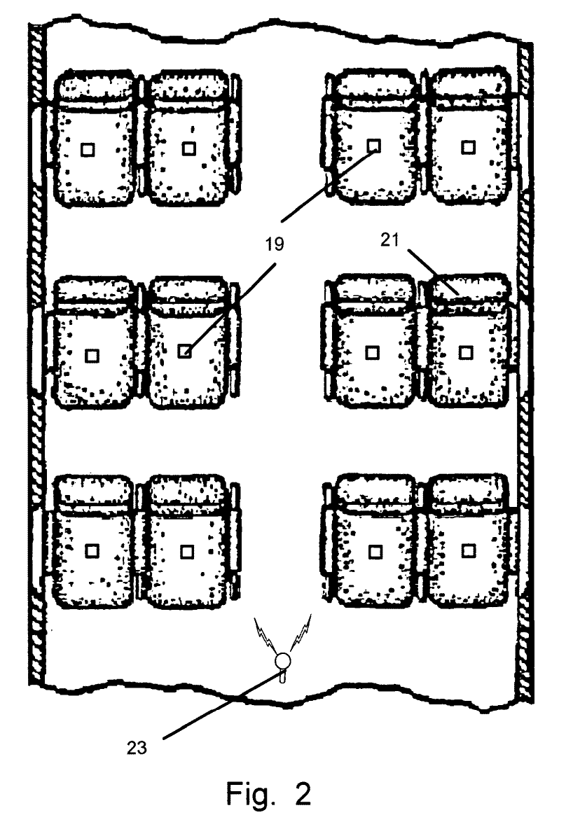

As noted, FIG. 1 depicts an exemplar display device 10 which provides an onboard screen display 12 viewable by the passenger. A keypad 14 and/or a touch screen 16 having displayed keys for choices provide for user input. In a particularly useful mode of the device 10, an onboard wireless receiver 18 adapted to energize and receive a location signal from a seat identification means such as an RFID 19 engaged to the seats 21 in a passenger cabin shown in FIG. 2. This enables the device 10 to ascertain the exact seat 21 in which the device 10 becomes located. This is done by the receiver 18 receiving seat information from a proximate RFID 19 or similar programmable passive or active broadcast device engaged to the seat 21.

The video display device 10 will display any of a plurality of different movies or videos that are broadcast in one or a plurality of decodable digital data streams to the display devices 10. Any of these individual movies or videos may be chosen by the user using the keys 14 or touchpad 16. In a preferred mode of the device 10, sufficient onboard computer memory provides electronic storage to the display device 10 to store a good portion of all of the chosen available movies and videos or multimedia broadcast in the datastream. The display devices 10 as noted can be loaded onto the passenger cabin prior to passengers and would download and store a portion of each of the available movie or video offerings in advance from the wireless transmitter 23 in the passenger cabin which would be engaged to onboard computers and electronic storage. In this fashion passengers on short flights will still be able to watch their desired movie or video without waiting for it to load into the device after the flight has started.

By broadcasting multiple offerings of audio and video in a datastream concurrently, once a user's display device decoded and separated the various offerings, portions may be stored in memory. Once one of the offerings is chosen by a user using the provided means to choose, the display device using a microprocessor and software will segment the portion of the datastream relating to the chosen audio or video and continue to cache it to memory even while the device 10 is playing the chosen offering. This minimizes the amount of memory required and eliminates the need for a hard drive since the broadcast datastream concurrently provides all of the displays in the passenger cabin with all of the offerings. Each individual device only segments the portion chosen by its user for viewing or listening and processes it to audio or video by decoding the digital signal in the datastream. Currently 8 individual audio or video offerings are provided in a single digital datastream and each device has software and sufficient memory to decode the data stream in real time and play the chosen portion.

Using wireless transmission from the transmitter 23 to a wireless receiver 27 on the display device 10 such as an infrared receiver and transmitter or RF transceiver or transmitter, or other means employable in the passenger cabin environment, the available and chosen movies or video or audio or other multimedia entertainment is broadcast in digital format downloaded to each individual display device 10. The different offerings for the trip are decoded from the data stream for storage and viewing. Because the location of each such display device 10 may be determined by the seat identifier such as the RFID 19 communicating with the display device 10 such programming might also be loaded in advance onto the display devices 10 based on preselection and payment by the passenger who knows their seat assignment. Because of limited bandwidth for the datastream of multiple offerings, and concerns about two way communication on airplanes, one preferred mode of operation would entail minimal transmissions from the display devices 10 themselves, and streaming transmissions in digital format of the multiple offerings to each display device 10 to minimize the need for onboard memory on the devices. Additionally preferred on a mode of the device would be a card slot 30 which would allow passengers to engage their own memory chip and view their own media on the display device 10.

Also in a preferred mode, the display devices 10 would be loaded with data as to the flights for the airline and a means to determine on which flight the device is located and the time. Using this information, and onboard software adapted to the to the task, the display devices 10 will ascertain how much time is still available for media viewing, before the flight will land. This will provide means to ascertain remaining time for video viewing and to notify the user if there is sufficient or insufficient time to watch the video they have chosen.

When employed with the RFID 19 or other seat identifiers, the seat location will be employed when the display device 10 is used by the passenger to communicate to the crew of the aircraft. Thus drink orders can be communicated and delivered to individual passengers using the display device 10 as the interface between passengers and an onboard computer used by the crew to watch and track passenger requests.

Also preferred as one channel broadcast to the display devices 10 will be a video graphic display of the aircraft (or bus or other vehicle) location on the map using GPS. This allows passengers to track their progress. The GPS may also be used by the device to ascertain if sufficient time is left for the chosen video by the passenger. A flight information button 20 or other touchscreen button would cause the information to be displayed.

Communication of video and other information to and from each display device 10 would be handled by wireless communication with a transmitter 23 on the aircraft and an onboard receiver 27 on the display devices 10 such as an infrared or RF or other transmitter in the plane, train or bus and appropriate receivers in the display devices 10 onboard. In the event that the display device 10 needs to transmit a choice by the user, the receiver 27 would also have a transmit function like a transceiver as would the transmitter 23.

The self orienting video display device 10 for use on an aircraft or other passenger vehicle and method shown in the drawings and described in detail herein features arrangements of elements of particular construction and configurations for preferred embodiments of the present invention. It is to be understood, however, that elements of different construction and configuration and other arrangements thereof, other than those illustrated and described, may be employed for providing a device within the spirit of this invention.

As such, while the present system and method of the invention has been described herein with reference to particular embodiments thereof, a latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention.

What is claimed is:

1. A portable multimedia apparatus for employment in a passenger cabin having a plurality of passenger seats, comprising:
a housing, said housing having a video display adapted to display video images and having an onboard electric power supply;
a sound reproduction component engaged within said housing;
means to receive wireless transmissions from a wireless transmitter;
electronic memory adapted to electronically store data convertible to one or a combination of sound and video which is communicated in said wireless transmissions;
a microprocessor in said housing, said microprocessor operatively engaged to said power supply, said electronic memory, said video display and said sound reproduction component;
software adapted to run on said microprocessor and process said data stored in said electronic memory to produce one or a combination of audio upon said sound reproduction component and video images upon said video display;
electronic means to ascertain a seat identification of each respective individual seat, from said plurality of passenger seats in said passenger cabin, when an individual said multimedia apparatus is placed upon, or in a close proximity to, said specific individual seat; and
said software adapted to ascertain a user's access rights, to employ said multimedia apparatus, based on a respective seat identification, whereby a plurality of said audio and video devices may be placed upon said plurality of passenger seats and users occupying said seats for a trip, can be assigned variable said access rights to employ a respective said multimedia apparatus which are identified with their respective passenger seat, to provide said passenger one or a combination of said sound and video.

2. The portable multimedia apparatus of claim 1 additionally comprising:
means for a user to input a choice to said multimedia apparatus, to play specific said audio or said video from a plurality of said choices made available, based on said respective user's respective said access rights to said multiple choices concurrently broadcast in a datastream in said wireless transmission.

3. The portable multimedia apparatus of claim 2 additionally comprising:
means to ascertain if a remaining time in said trip is sufficient to complete said choice by said user; and
audio or video means to notify said passenger if said remaining time in said trip is insufficient for said choice.

4. The portable multimedia apparatus of claim 2 additionally comprising:
said means to input a choice also allowing for a communication to crew members of a user request; and
means to transmit said user request, and said seat identification wirelessly to a receiver viewable by crew members tending said passenger cabin, whereby specific said user requests can be communicated to said crew members along with said seat identification to identify a specific passenger to said crew members.

5. The portable multimedia apparatus of claim 2 additionally comprising:
said means to receive wireless transmissions from a wireless transmitter being configured to receive and store individual portions of said data in said electronic memory prior to a start of said trip in a pre-loading of said data;
said individual portions being a beginning segment of complete movies; and
said means to receive wireless transmissions from a wireless transmitter configured to receive respective remaining portions of a said complete movie, subsequent to an individual said user making said choice and picking a respective said individual movie, whereby a lessening requirement for said electronic memory is provided by said pre-loading of said data and a subsequent transmission of said remaining portion.

6. The portable multimedia apparatus of claim 3 additionally comprising:
said means to receive wireless transmissions from a wireless transmitter being configured to receive and store individual portions of said data in said electronic memory prior to a start of said trip in a pre-loading of said data;
said individual portions being a beginning segment of one or a plurality of complete movies; and
said means to receive wireless transmissions from a wireless transmitter configured to receive respective remaining portions of a said complete movie, subsequent to an individual said user making said choice and picking a respective said individual movie only if said means to ascertain if a remaining time in said trip is sufficient to complete said choice by said user, whereby a lessening requirement for said electronic memory is provided by said pre-loading of said data and a subsequent transmission of said remaining portion.

9. The portable multimedia apparatus of claim 2 additionally comprising:
said wireless transmissions including a catalog of available goods or services which may be ordered by a said user;
said choice by said user serving to order said goods or services; and
means to transmit said choice by said user wirelessly to a receiver of a provider of said goods or services for delivery.

10. The portable multimedia apparatus of claim 5 additionally comprising:
said means to receive wireless transmissions from a wireless transmitter being configured to receive and store individual portions of said data in said electronic memory prior to a start of said trip in a pre-loading of said data;
means for users knowing their seat assignment in advance of said trip, to communicate said choice prior to said trip; and
said individual portions including all or a beginning segment of a complete movies designated by said choice, whereby said multimedia apparatus may be programmed with said data based on said choice by said user in advance of said trip and placed in said seat of said passenger for said trip.

11. The portable multimedia apparatus of claim 1 wherein said electronic means to ascertain a seat identification of each respective individual seat is comprised of an RFID engaged to each of said seats in said plurality of seats and a receiver engaged to said housing adapted to energize and receive an identification signal from said RFID.

12. The portable multimedia apparatus of claim 2 wherein said electronic means to ascertain a seat identification of each respective individual seat is comprised of an RFID engaged to each of said seats in said plurality of seats and a receiver engaged to said housing adapted to energize and receive an identification signal from said RFID.

13. The portable multimedia apparatus of claim 4 wherein said electronic means to ascertain a seat identification of each respective individual seat is comprised of an RFID engaged to each of said seats in said plurality of seats and a receiver engaged to said housing adapted to energize and receive an identification signal from said RFID.

14. The portable multimedia apparatus of claim 5 wherein said electronic means to ascertain a seat identification of each respective individual seat is comprised of an RFID engaged to each of said seats in said plurality of seats and a receiver engaged to said housing adapted to energize and receive an identification signal from said RFID.
